(19) United States
(12) Patent Application Publication
(10) Pub. No.: US 2008/0167397 A1
(43) Pub. Date: Jul. 10, 2008

(54) Coating Compositions

(75) Inventors: Shaun L. Herlihy, Kent (GB); Stephen S. Standing, Kent (GB); Robert S. Davidson, Leicester (GB)

Correspondence Address: DICKSTEIN SHAPIRO, 1177 AVENUE OF THE AMERICAS (6TH AVENUE), NEW YORK, NY, 10036-2714, US

(73) Assignee: SUN CHEMICAL CORPORATION, Parsippany, NJ (US)

(21) Appl. No.: 11/883,921

(22) PCT Filed: Feb. 16, 2006
(86) PCT No.: PCT/US06/05443

§ 371 Date: Aug. 8, 2007

(30) Foreign Application Priority Data
Feb. 25, 2005 (GB) 0503948.2

(51) Int. Cl. C08F 2/46; B05D 3/10

(52) U.S. Cl. 522/75; 427/508; 427/487

(57) ABSTRACT

In a cationically curable composition comprising an epoxide, a cationic photoinitiator and a cyclic carbonate, we have found that the use of higher levels of cyclic carbonate than have been used hitherto can lead to much enhanced cure speed and post-cure.

The present invention relates to new energy-curable coating compositions, such as printing inks or varnishes, having excellent cure and, if desired, a relatively low viscosity, as a result of the incorporation in the composition of unprecedentedly high levels of cyclic carbonates.

Although cationic curing of printing inks on exposure to ultraviolet radiation (UV) by the ring-opening polymerisation of epoxides has been known for a very long time, it has never achieved much commercial success, as a result, inter alia, of the slow cure speed of such systems. In order to make such systems commercially attractive, it is necessary to improve the cure speed of UV cationically curable epoxide-based printing inks and similar coating compositions.

We have surprisingly found that this may be achieved by the incorporation in the coating composition of relatively high levels of one or more cyclic carbonates, such as propylene carbonate. This finding is the more surprising, since propylene carbonate, in particular, is commonly used as a solvent for the cationic photoinitiator in such systems (the cationic photoinitiator commonly being used as a 50% solution in propylene carbonate) and since there is pressure from users of these coating compositions to reduce the level of propylene carbonate, on the basis that it may migrate out of the cured composition. Moreover, propylene carbonate is deemed by most formulators and end users to be an unreactive component, and so it would not be expected to have a positive effect on cure. Indeed, U.S. Pat. No. 5,262,449 is not alone in stating specifically that simple alkylene carbonates are merely solvents and play no part in polymerisation, and that they should be used in relatively low amounts to avoid undesired effects.

Since the level of propylene carbonate in prior art compositions is determined by the level of cationic photoinitiator, it is readily possible to determine the levels of propylene carbonate in the resulting compositions. In general, sulphonium salt cationic photoinitiators have been used in the prior art at levels of from 8 to 10% by weight, and so the level of propylene carbonate in such compositions would be from 4 to 5% by weight.

Carroy [“New Developments in Cationic Curing Flexo Inks”, a paper presented at RadTech e/5 2004 Technical Proceedings] discloses a composition containing about 13.4% propylene carbonate, but attributes the results he achieved to the excellent thioxanthonium cationic photoinitiator which he used and its good dissolution in the printing ink. Specifically, the composition disclosed by Carroy comprises 57.1% 3,4-epoxy-cyclohexylmethyl-3′,4′-epoxycyclohexane carboxylate, 10.0% 3-ethyl-3-hydroxymethyl-oxetane, 15.0% pigment, 17.4% 10-biphenyl-4-yl-2-isopropyl-9-oxo-9H-thioxanthen-10-ium hexafluorophosphate as a 23% solution in propylene carbonate, and 0.5% levelling additive.

JP 2004-32361 (Konica Minolta) also discloses a coating composition for ink jet use that contains either a cyclic ester compound (in an amount between 2.5 and 20 mass %, preferably between 5.0 and 15 mass %, of the total ink mass) or propylene carbonate (in unspecified amounts).

In accordance with the present invention, we have found that significantly higher levels of a cyclic carbonate, such as propylene carbonate, than are conventionally used are needed in order to achieve the desired enhanced cure speed.

Thus, in one aspect, the present invention consists in an energy-curable coating composition comprising an epoxide monomer or oligomer, a cationic photoinitiator and a cyclic carbonate, the cyclic carbonate being present in an amount of at least 12% by weight of the entire composition, provided that the composition does not comprise 57.1% 3,4-epoxy-cyclohexylmethyl-3′,4′-epoxycyclohexane carboxylate, 10.0% 3-ethyl-3-hydroxymethyl-oxetane, 15.0% pigment, 17.4% 10-biphenyl-4-yl-2-isopropyl-9-oxo-9H-thioxanthen-10-ium hexafluorophosphate as a 23% solution in propylene carbonate, and 0.5% levelling additive.

In a further aspect, the present invention consists in an energy-curable coating composition comprising an epoxide monomer or oligomer, a cationic photoinitiator and a cyclic carbonate other than propylene carbonate.

In a still further aspect, the present invention consists in an energy-curable coating composition comprising an epoxide monomer or oligomer, a cationic photoinitiator and a cyclic carbonate, the cyclic carbonate being present in an amount of from 15% to 35% by weight of the entire composition.

In addition to the above, the compositions of the present invention may also contain an oxetane monomer or oligomer. These compounds are capable of polymerising by a cationically induced ring-opening reaction. Examples of suitable oxetanes include 3-ethyl-3-hydroxymethyl-oxetane or 3-ethyl-3-[2-ethylhexyloxy)-methyl]oxetane. However, the compositions of the present invention are preferably free from added mono-functional oxetanes.

Typical epoxides which may be used include the cycloaliphatic epoxides (such as those sold under the designations Cyracure UVR6105, UVR6107, UVR6110 and UVR6128, by Dow), which are well known to those skilled in the art.

Other epoxides which may be used include such epoxy-functional oligomers/monomers as the glycidyl ethers of polyols [bisphenol A, alkyl diols or poly(alkylene oxides), which be di-, tri-, tetra- or hexa-functional]. Also, epoxides derived by the epoxidation of unsaturated materials may also be used (e.g. epoxidised soybean oil, epoxidised polybutadiene or epoxidised alkenes). Naturally occurring epoxides may also be used, including the crop oil collected from Vernonia galamensis.

As well as epoxides and optionally oxetanes, other reactive monomers/oligomers which may be used include the vinyl ethers of polyols [such as triethylene glycol divinyl ether, 1,4-cyclohexane dimethanol divinyl ether and the vinyl ethers of poly(alkylene oxides)]. Examples of vinyl ether functional prepolymers include the urethane-based products supplied by Allied Signal. Similarly, monomers/oligomers containing propenyl ether groups may be used in place of the corresponding compounds referred to above containing vinyl ether groups.

Other reactive species can include styrene derivatives and cyclic esters (such as lactones and their derivatives).

The composition of the present invention also contains a cationic photoinitiator. There is no particular restriction on the particular cationic photoinitiator used, and any cationic photoinitiator known in the art may be employed. Examples of such cationic photoinitiators include sulphonium salts (such as the mixture of compounds available under the trade name UVI6992 from Dow Chemical), thianthrenium salts (such as Esacure 1187 available from Lamberti), iodonium salts (such as IGM 440 from IGM) and phenacyl sulphonium salts. However, particularly preferred cationic photoinitiators are the thioxanthonium salts, such as those described in WO 03/072567 A1, WO 03/072568 A1, and WO 2004/055000 A1, the disclosures of which are incorporated herein by reference.

Particularly preferred thioxanthonium salts are those of formulae (I), (II) and (III):

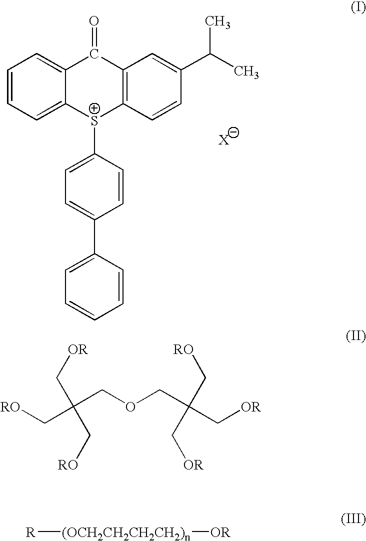

in which each R represents a group of formula (IV):

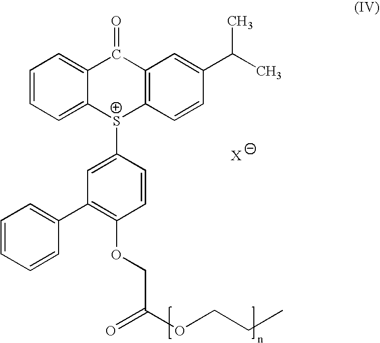

where n is a number and X⁻ is an anion, especially the hexafluorophosphates. The hexafluorophosphates of the compounds of formulae (I) and (II) are available from Robinson Brothers Ltd. under the trade marks “Meerkat” and “Bobcat”, respectively, or from IGM under the trade marks IGM 550 and IGM 650 respectively.

The compositions of the present invention also contain a cyclic carbonate at a level higher than is conventionally used, when it is merely present as a solvent for the cationic photoinitiator, i.e. at a level of at least 7% by weight of the entire composition, preferably at least 8% by weight of the entire composition, more preferably at least 10% by weight of the entire composition, and most preferably at least 15% by weight of the entire composition. The amount of cyclic carbonate can go up to very high levels, far beyond what would previously have been considered sensible, even as far as 40% by weight of the entire composition, although, at such a level, its presence will tend to degrade the properties of the cured coating composition, and a more reasonable maximum is 35%, still more preferably 30%. In general, an amount of from 8% to 35% by weight of the entire composition is preferred, more preferably from 10% to 30% by weight of the entire composition, still more preferably from 12% to 25% by weight of the entire composition, and most preferably from 15% to 25% by weight of the entire composition.

The cyclic carbonate used may be any known in the art, preferably one that can act as a solvent for at least some part of the composition of the present invention prior to curing. Preferred cyclic carbonates are those having a 5-membered ring. Examples of suitable cyclic carbonates include compounds of formula (V):

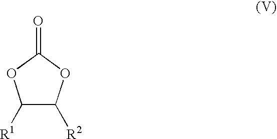

in which R¹ and R² are the same as or different from each other and each represents a hydrogen atom, a C₁-C₃ alkyl group, a C₁-C₃ hydroxyallyl group or a C₂-C₃ alkenyl group.

Where R¹ and/or R² represents an alkyl group, this may be, for example, a methyl, ethyl, propyl or isopropyl group, the methyl group being preferred. Where R¹ and/or R² represents a hydroxyalkyl group, this may be, for example, a hydroxymethyl, 1-hydroxyethyl, 2-hydroxyethyl, 2-hydroxypropyl or 3-hydroxypropyl group, the hydroxymethyl group being preferred. Where R¹ and/or R² represents an alkenyl group, this may be a vinyl or allyl group, the vinyl group being preferred.

Specific examples of such cyclic carbonates include propylene carbonate, glycerine carbonate, vinyl ethylene carbonate, ethylene carbonate and butylene carbonate, of which propylene carbonate is preferred.

The composition of the present invention may be formulated as a printing ink, varnish, adhesive, paint or any other coating composition which is intended to be cured by energy, which may be supplied by irradiation, whether by ultraviolet or electron beam. Such compositions will normally contain at least a polymerisable monomer, prepolymer or oligomer, and a cationic photoinitiator, as well as the cyclic carbonate, but may also include other components well known to those skilled in the art, for example, reactive diluents and, in the case of printing inks and paints, a pigment or dye.

It is also common to include polyols in ultraviolet cationic curable formulations, which promote the cross-linking by a chain-transfer process. Examples of polyols include the ethoxylated/propoxylated derivatives of, for example, trimethylolpropane, pentaerythritol, di-trimethylolpropane, di-pentaerythritol and sorbitan esters, as well as more conventional poly(ethylene oxide)s and poly(propylene oxide)s. Other polyols well known to those skilled in the art are the polycaprolactone diols, triols and tetraols, such as those supplied by Dow.

Additives which may be used in conjunction with the principal components of the coating formulations of the present invention include stabilisers, plasticisers, pigments, waxes, slip aids, levelling aids, adhesion promoters, surfactants and fillers.

The amounts of the various components of the curable composition of the present invention may vary over a wide range and, in general, are not critical to the present invention. However, we prefer that the amount of the polymerisable components (i.e. the epoxide, oxetane, if used, and other monomers, prepolymers and oligomers, if used) should be from 40 to 90% of the total composition. The epoxide(s) preferably comprise from 30 to 80% of the polymerisable components in the composition of the present invention, and the oxetanes, preferably multi-functional oxetane(s), if used, preferably comprise from 5 to 40% of the polymerisable components in the composition of the present invention. The amount of cationic photoinitiator is normally from 1.0 to 10% by weight, more preferably from 2.0 to 8%, by weight of the entire composition.

Other components of the curable composition may be included in amounts well known to those skilled in the art.

The curable compositions of this invention may be suitable for applications that include protective, decorative and insulating coatings; potting compounds; sealants; adhesives; photoresists; textile coatings; and laminates. The compositions may be applied to a variety of substrates, e.g., metal, rubber, plastic, wood, moulded parts, films, paper, glass cloth, concrete, and ceramic. The curable compositions of this invention are particularly useful as inks for use in a variety of printing processes, including, but not limited to, flexography, inkjet and gravure. Details of such printing processes and of the properties of inks needed for them are well known and may be found, for example, in The Printing Ink Manual, 5^{th} Edition, edited by R. H. Leach et al., published in 1993 by Blueprint, the disclosure of which is incorporated herein by reference.

Where the compositions of the present invention are used for inks, these typically comprise, as additional components to those referred to above, one or more of pigments, waxes, stabilisers, and flow aids, for example as described in “The Printing Ink Manual”.

Thus, the invention also provides a process for preparing a cured coating composition, which comprises applying a composition according to the present invention to a substrate and exposing the coated substrate to curing radiation sufficient to cure the coating.

The invention is further illustrated by the following non-limiting Examples. Percentages are by weight.

### EXAMPLE 1

Varnish formulations were prepared based on 2% Meerkat photoinitiator, 0.1% Tegorad 2100 wetting aid, variable levels of propylene carbonate (as shown in Table 1), with the remainder being UVR6105 cycloaliphatic epoxide. All formulations were printed using a number 1 K bar onto Leneta charts and cured with a single pass at 100 m/minute using 1× 300 W/inch medium pressure mercury lamp operating at half power. Cure was assessed using the well known MEK (methyl ethyl ketone) solvent rub method immediately after cure, 5 minutes after cure and 15 minutes after cure. The results are shown in the following Table 1.

TABLE 1

| % propylene | MEK double rubs | | |
|---|---|---|---|
| carbonate | Immediate | T = 5 minutes | T = 15 minutes |
| 1 | 7 | 10 | 11 |
| 5 | 6 | 21 | 30 |
| 10 | 7 | 29 | 48 |
| 15 | 9 | 48 | >50 |
| 20 | 13 | >50 | >50 |
| 25 | 11 | 30 | 46 |
| 30 | 9 | 14 | 22 |
| 40 | 7* | 5 | 9 |
| 50 | 5* | 3* | 5 |

*coating tacky or wet

The photoinitiator Meerkat (10-biphenyl-4-yl-2-isopropyl-9-oxo-9H-thioxanthen-10-ium hexafluorophosphate) was obtained from Robinson Brothers
Tegorad 2100 is a wetting aid obtained from the Tego Corporation
The cycloaliphatic epoxide resin UVR6105 (3,4-epoxycyclohexylmethyl 3,4-epoxycyclohexane carboxylate) was obtained from DOW
Propylene carbonate was obtained from Aldrich
   These results indicate that, far from behaving as an inert solvent, propylene carbonate is providing a substantial cure benefit in terms of the rate at which the post -cure properties are developing. Optimum cure efficiency is obtained at a level of approximately 20% by weight of propylene carbonate, corresponding to a weight ratio of approximately 4 UVR6105:1 propylene carbonate and a molar ratio of around 3.8 epoxide groups to 1 carbonate.

### EXAMPLE 2

Varnish formulations were prepared based on 2% Meerkat photoinitiator, 0.1% Tegorad 2100 wetting aid, variable levels of ethylene, vinyl ethylene or glycerine carbonate (as shown in Tables 2-4), with the remainder being UVR6105 cycloaliphatic epoxide. All formulations also contain 1% of propylene carbonate which is used in a photoinitiator concentrate when preparing the samples. All formulations were printed using a number 1 K bar onto Leneta charts and cured with a single pass at 100 m/minute using 1× 300 W/inch medium pressure mercury lamp operating at half power. Cure was assessed using the well known MEK solvent rub method immediately after cure, 5 minutes after cure and 15 minutes after cure. The results are shown in the following Tables 2-4.

TABLE 2

| % ethylene | MEK double rubs | | |
|---|---|---|---|
| carbonate | Immediate | T = 5 minutes | T = 15 minutes |
| 0 | 3 | 5 | 5 |
| 5 | 3 | 10 | 23 |
| 10 | 3 | 36 | >50 |
| 15 | 5 | >50 | >50 |
| 20 | 11 | >50 | >50 |
| 25 | 9 | >50 | >50 |
| 30 | 6 | 47 | >50 |

TABLE 3

| % vinyl | | | |
|---|---|---|---|
| ethylene | MEK double rubs | | |
| carbonate | Immediate | T = 5 minutes | T = 15 minutes |
| 0 | 6 | 12 | 8 |
| 2.5 | 8 | 20 | 29 |
| 5 | 6 | 17 | 39 |
| 10 | 9 | 48 | >50 |
| 15 | 10 | >50 | >50 |
| 20 | 9 | 40 | >50 |
| 25 | 7 | 13 | 30 |
| 30 | 8 | 9 | 13 |

TABLE 4

| % glycerine | MEK double rubs | | |
|---|---|---|---|
| carbonate | Immediate | T = 5 minutes | T = 15 minutes |
| 0 | 7 | 10 | 10 |
| 5 | 7 | 14 | 21 |
| 10 | 7 | 18 | 40 |
| 15 | 6 | 28 | >50 |
| 20 | 7 | 29 | >50 |
| 25 | 7 | 20 | 28 |
| 30 | 9 | 9 | 4 |
| 40 | 5* | 5 | 9 |

*coating tacky or wet

These results indicate that all the simple 5 membered cyclic carbonates tested demonstrate a strong post-cure promoting effect similar to that observed with propylene carbonate in Example 1.
Ethylene carbonate and vinyl ethylene carbonate were obtained from Aldrich
Glycerine carbonate was obtained from Huntsman as Jeffsol GC

### EXAMPLE 3

Varnish formulations were prepared based on 2% Meerkat photoinitiator, 0.1% Tegorad 2100 wetting aid, 0%, 5% or 20% propylene carbonate with the remainder being UVR6105 cycloaliphatic epoxide. All formulations were printed using a number 1 K bar onto Leneta charts and cured at a range of UV doses by changing the lamp power and line speed. UV dose was measured using an EIT Uvicure light bug measuring only in the UVB region of the spectrum. Cure was assessed using the well known MEK solvent rub method immediately after cure and 1 hour after cure. The results are shown in Tables 5 and 6.

TABLE 5
MEK double rubs immediately after cure

| | | | Immediate MEK double rubs | | |
|---|---|---|---|---|---|
| | | | 0% | 5% | 20% |
| UVB dose | Line speed | Lamp | propylene | propylene | propylene |
| J/cm² | m/min | power | carbonate | carbonate | carbonate |
| 0.018 | 120 | Half | 2 | 3 | 9 |
| 0.022 | 100 | Half | 2 | 2 | 8 |
| 0.027 | 80 | Half | 2 | 2 | 9 |
| 0.031 | 120 | Full | 3 | 3 | 9 |
| 0.035 | 60 | Half | 2 | 2 | 12 |
| 0.038 | 100 | Full | 2 | 3 | 11 |
| 0.046 | 80 | Full | 2 | 3 | 20 |
| 0.053 | 40 | Half | 2 | 2 | 11 |
| 0.061 | 60 | Full | 2 | 3 | 22 |
| 0.073 | 50 | Full | 2 | 3 | 48 |
| 0.091 | 40 | Full | 1 | 2 | >50 |
| 0.109 | 20 | Half | 2 | 2 | 48 |
| 0.124 | 30 | Full | 1 | 3 | >50 |
| 0.186 | 20 | Full | 1 | 2 | >50 |
| 0.232 | 10 | Half | 1 | 2 | >50 |
| 0.251 | 15 | Full | 1 | 2 | >50 |
| 0.372 | 10 | Full | 1 | 3 | >50 |

TABLE 6
MEK double rubs 1 hour after cure

| | | | MEK double rubs after 1 hour | | |
|---|---|---|---|---|---|
| | | | 0% | 5% | 20% |
| UVB dose | Line speed | Lamp | propylene | propylene | propylene |
| J/cm^{z} | m/min | power | carbonate | carbonate | carbonate |
| 0.018 | 120 | Half | 5 | 27 | >50 |
| 0.022 | 100 | Half | 7 | 36 | >50 |
| 0.027 | 80 | Half | 7 | 40 | >50 |
| 0.031 | 120 | Full | 6 | 26 | >50 |
| 0.035 | 60 | Half | 9 | 39 | >50 |
| 0.038 | 100 | Full | 6 | 48 | >50 |
| 0.046 | 80 | Full | 6 | 40 | >50 |
| 0.053 | 40 | Half | 5 | 40 | >50 |
| 0.061 | 60 | Full | 4 | 48 | >50 |
| 0.073 | 50 | Full | 3 | 42 | >50 |
| 0.091 | 40 | Full | 2 | 32 | >50 |
| 0.109 | 20 | Half | 3 | 43 | >50 |
| 0.124 | 30 | Full | 2 | 25 | >50 |
| 0.186 | 20 | Full | 2 | 13 | >50 |
| 0.232 | 10 | Half | 2 | — | >50 |
| 0.251 | 15 | Full | 2 | 13 | >50 |
| 0.372 | 10 | Full | 2 | 9 | >50 |

These results indicate that in cationic formulations based on cycloaliphatic epoxide, in the absence of, or at relatively low levels (5%) of, propylene carbonate the cure and post-cure reaction is either unaffected or retarded by increasing UV dose. Conversely, at high levels of propylene carbonate (20%) this effect is completely reversed and both cure and post-cure are significantly enhanced with increasing Uv dose. All samples in this example cured tack free with a single pass.

### EXAMPLE 4

Varnish formulations were prepared based on different types of cationic photoinitiator, 0.1% Tegorad 2100 wetting aid, low and high levels of propylene carbonate, with the balance of the formulation being UVR6105 cycloaliphatic epoxide. All formulations were printed using a number 1 K bar onto Leneta charts and cured with a single pass at 100 m/minute using 1× 300 W/inch medium pressure mercury lamp operating at half power. Cure was assessed using the well known MEK solvent rub method at various time intervals after cure. The results are shown in Table 7.

TABLE 7

| | % | MEK double rubs | | |
|---|---|---|---|---|
| | propylene | | T = 5 | T = 15 |
| Photoinitiator | carbonate | Immediate | minutes | minutes |
| 2% Meerkat | 1* | 7 | 10 | 11 |
| 2% Meerkat | 20 | 13 | >50 | >50 |
| 4% UVI6992 | 2** | 2 | 4 | 4 |
| 4% UVI6992 | 20 | 7 | >50 | >50 |
| 2% IGM 440 | 0 | 3 | 2 | 2 |
| 1% Irgacure 184 | | | | |
| 2% IGM 440 | 20 | 6 | >50 | >50 |
| 1% Irgacure 184 | | | | |

*used in the photoinitiator concentrate solution when preparing samples
**photoinitiator supplied commercially as 50% solution in propylene carbonate
IGM 440 is 4,4’-dimethyl-diphenyl iodoniuin hexafluorophosphate from IGM
Irgacure 184 is 1-hydroxycyclohexylphenyl ketone ex CIBA, which is both a free radical photoinitiator and a well known sensitiser of iodonium salt cationic photoinitiators
UVI 6992 is a mixture of triaryl sulphonium salt compounds supplied as a 50 % solution in propylene carbonate by DOW

These results demonstrate that the cure benefit resulting from the use of high levels of propylene carbonate is independent of the type of cationic photoinitiator system used.

### EXAMPLE 5

White ink formulations suitable for flexographic printing were prepared based on;

| | |
|---|---|
| 3.6%% | Meerkat photoinitiator |
| 1.0% | Solsperse 32000 pigment dispersion aid ex. Lubrizol |
| 0.2% | Airex 920 anti-foam ex. Tego |
| 40.0% | Finnititan RDI/S Titanium dioxide pigment ex. Kemira OY |
| 5-22.5% | propylene carbonate |
| 50.2-32.7% | UVR6105 cycloaliphatic epoxide |

All formulations were printed using an “Easiproof” hand anilox coater using a #300/32 anilox onto PET (polyethylene terephthalate) substrate and cured with a single pass at 146 m/minute using 1× 300 W/inch medium pressure mercury lamp operating at full power. Cure was assessed using the well known IPA (isopropyl alcohol) solvent rub method 25 second and 15 minutes after cure. The results are shown in the following Table 8

TABLE 8

| | | IPA rubs | | |
|---|---|---|---|---|
| | | Weight ratio | | |
| % | | UVR6105: | | |
| propylene | | propylene | T = 25 | T = 15 |
| carbonate | % UVR 6105 | carbonate | seconds | minutes |
| 5 | 50.2 | 10.0 | 8 | 65 |
| 7.5 | 47.7 | 6.4 | 8 | 80 |
| 10 | 45.2 | 4.5 | 12 | >100 |
| 12.5 | 42.7 | 3.4 | 11 | >100 |
| 15 | 40.2 | 2.7 | 12 | 43 |
| 17.5 | 37.7 | 2.2 | 12 | 34 |
| 20 | 35.2 | 1.8 | 5 | 20 |
| 22.5 | 32.7 | 1.4 | 4 | 4 |

These results in white ink formulations support those of Example 1 and demonstrate that optimum cure efficiency is obtained at a level of approximately 10 to 12.5% by weight of propylene carbonate, corresponding to a weight ratio of between 3.4 & 4.5 UVR6105:1 propylene carbonate.

### COMPARATIVE EXAMPLE 1

Varnish formulations were prepared based on 2% Meerkat photoinitiator, 0.1% Tegorad 2100 wetting aid, variable levels of ε-caprolactone with the remainder being UVR6105 cycloaliphatic epoxide. All formulations also contain 1% of propylene carbonate which is used in a photoinitiator concentrate when preparing the samples. All formulations were printed using a number 1 K bar onto Leneta charts and cured with a single pass at 100 m/minute using 1× 300 W/inch medium pressure mercury lamp operating at half power. Cure was assessed using the well known MEK solvent rub method immediately after cure, 5 minutes after cure and 15 minutes after cure. The results are shown in the following Table 9.

TABLE 9

| | MEK double rubs | | |
|---|---|---|---|
| % e-caprolactone | Immediate | T = 5 minutes | T = 15 minutes |
| 0 | 5 | 7 | 12 |
| 2.5 | 6 | 8 | 10 |
| 5 | 5 | 8 | 9 |
| 10 | 5 | 9 | 12 |
| 15 | 5 | 9 | 12 |
| 20 | 5* | 7 | 11 |
| 25 | 5* | 7 | 7 |
| 30 | 4* | 6 | 4 |

*coating tacky or wet

These results indicate that, although ε-caprolactone is an effective diluent with similar viscosity and viscosity reducing power to propylene carbonate, it has no influence on the promotion of post-cure in the printed formulation and, by inference, plays no significant part in the chemical reactions taking place during the initial cure and post-cure processes.

### COMPARATIVE EXAMPLE 2

Varnish formulations were prepared based on 2% Meerkat photoinitiator, 0.1% Tegorad 2100 wetting aid, variable levels of RAPICURE PEPC with the remainder being UVR6105 cycloaliphatic epoxide. All formulations also contain 1% of propylene carbonate which is used in a photoinitiator concentrate when preparing the samples. All formulations were printed using a number 1 K bar onto Leneta charts and cured with a single pass at 100 m/minute using 1× 300 W/inch medium pressure mercury lamp operating at half power. Cure was assessed using the well known MEK solvent rub method immediately after cure, 5 minutes after cure and 15 minutes after cure. The results are shown in the following Table 10.

TABLE 10

| | MEK double rubs | | |
|---|---|---|---|
| % RAPICURE PEPC | Immediate | T = 5 minutes | T = 15 minutes |
| 0 | 4 | 9 | 14 |
| 2.5 | 4 | 7 | 13 |
| 5 | 4 | 10 | 17 |
| 10 | 5 | 8 | 25 |
| 15 | 5 | 10 | 21 |
| 20 | 4* | 7 | 13 |
| 25 | 4* | 5 | 7 |
| 30 | 4* | 4 | 6 |

*coating tacky or wet

RAPICURE PEPC (propenyl ether of propylene carbonate) was obtained from International Specialty Products (ISP)

These results indicate that, although RAPICURE PEPC is also effective at promoting post-cure in the printed formulation, it is by no means as effective at doing so as simple aliphatic carbonates such as propylene and ethylene carbonate.

### COMPARATIVE EXAMPLE 3

Varnish formulations were prepared based on increasing levels of Meerkat photoinitiator, 0.1% Tegorad 2100 wetting aid and UVR6105 cycloaliphatic epoxide. All formulations contain 4% of propylene carbonate. All formulations were printed using an “Easiproof” hand anilox coater using a #300/41 anilox onto Leneta charts and cured with a single pass at 100 m/minute using 1× 300 W/inch medium pressure mercury lamp operating at half power. Cure was assessed using the well known MEK solvent rub method immediately after cure, 5 minutes after cure and 15 minutes after cure. The results are shown in the following Table 11.

TABLE 11

| | MEK double rubs | | |
|---|---|---|---|
| % Photoinitiator | Immediate | T = 5 minutes | T = 15 minutes |
| 1 | Sample fails to cure | | |
| 1.5 | 5 | 4 | 6 |
| 2 | 5 | 5 | 6 |
| 2.5 | 5 | 10 | 9 |
| 3 | 5 | 7 | 12 |
| 3.5 | 5 | 8 | 12 |
| 4 | 5 | 8 | 14 |
| 4.5 | 6 | 12 | 15 |
| 5 | 5 | 11 | 17 |
| 6 | 5 | 11 | 16 |
| 7 | 5 | 9 | 15 |
| 8 | 5 | 6 | 14 |

These results indicate that at a constant low level of cyclic carbonate the level of photoinitiator has no effect on promoting post-cure in the printed formulations.

1. An energy-curable coating composition comprising an epoxide monomer or oligomer, a cationic photoinitiator and a cyclic carbonate, the cyclic carbonate being present in an amount of at least 12% by weight of the entire composition, provided that the composition does not comprise 57.1% 3,4-epoxy-cyclohexylmethyl-3′,4′-epoxycyclohexane carboxylate, 10.0% 3-ethyl-3-hydroxymethyl-oxetane, 15.0% pigment, 17.4% 10-biphenyl-4-yl-2-isopropyl-9-oxo-9H-thioxanthen-10-ium hexafluorophosphate as a 23% solution in propylene carbonate, and 0.5% levelling additive.

2. A composition according to claim 1, in which the cyclic carbonate is present in an amount of at least 15% by weight of the entire composition.

3. A composition according to claim 1, in which the cyclic carbonate is present in an amount of from 12% to 35% by weight of the entire composition.

4. A composition according to claim 3, in which the cyclic carbonate is present in an amount of from 12% to 30% by weight of the entire composition.

5. A composition according to claim 4, in which the cyclic carbonate is present in an amount of from 12% to 25% by weight of the entire composition.

6. A composition according to claim 5, in which the cyclic carbonate is present in an amount of from 15% to 25% by weight of the entire composition.

7. A composition according to claim 1, additionally comprising an oxetane monomer.

8. A composition according to claim 7, in which the oxetane is 3-ethyl-3-hydroxymethyl-oxetane or 3-ethyl-3-[(2-ethylhexyloxy)methyl]oxetane.

9. A composition according to claim 1, in which the cyclic carbonate is propylene carbonate, glycerine carbonate, vinyl ethylene carbonate, ethylene carbonate or butylene carbonate.

10. A composition according to claim 9, in which the cyclic carbonate is propylene carbonate.

11. A composition according to claim 1, in the form of a printing ink or varnish.

12. A composition according to claim 1, formulated for inkjet printing.

13. A process for preparing a cured coating composition, which comprises applying a composition according to claim 1 to a substrate and exposing the coated substrate to curing radiation sufficient to cure the coating.

14. A process according to claim 13, in which the curing radiation is ultraviolet.

15. An energy-curable coating composition comprising an epoxide monomer or oligomer, a cationic photoinitiator and a cyclic carbonate other than propylene carbonate.

16. A composition according to claim 15, in which the cyclic carbonate is present in an amount of at least 2% by weight of the entire composition.

17. A composition according to claim 16, in which the cyclic carbonate is present in an amount of at least 7% by weight of the entire composition.

18. A composition according to claim 17, in which the cyclic carbonate is present in an amount of at least 8% by weight of the entire composition.

19. A composition according to claim 18, in which the cyclic carbonate is present in an amount of at least 10% by weight of the entire composition.

20. A composition according to claim 19, in which the cyclic carbonate is present in an amount of at least 15% by weight of the entire composition.

21. A composition according to claim 15, in which the cyclic carbonate is present in an amount of from 8% to 35% by weight of the entire composition.

22. A composition according to claim 21, in which the cyclic carbonate is present in an amount of from 10% to 30% by weight of the entire composition.

23. A composition according to claim 22, in which the cyclic carbonate is present in an amount of from 12% to 25% by weight of the entire composition.

24. A composition according to claim 23, in which the cyclic carbonate is present in an amount of from 15% to 25% by weight of the entire composition.

25. A composition according to claim 15, additionally comprising an oxetane monomer.

26. A composition according to claim 25, in which the oxetane is 3-ethyl-3-hydroxymethyl-oxetane or 3-ethyl-3-[(2-ethylhexyloxy)methyl]oxetane.

27. A composition according to claim 15, in which the cyclic carbonate is glycerine carbonate, vinyl ethylene carbonate, ethylene carbonate or butylene carbonate.

28. A composition according to claim 15, in the form of a printing ink or varnish.

29. A composition according to claim 15, formulated for inkjet printing.

30. A process for preparing a cured coating composition, which comprises applying a composition according to claim 15 to a substrate and exposing the coated substrate to curing radiation sufficient to cure the coating.

31. A process according to claim 30, in which the curing radiation is ultraviolet.

32. An energy-curable coating composition comprising an epoxide monomer or oligomer, a cationic photoinitiator and a cyclic carbonate, the cyclic carbonate being present in an amount of from 15% to 35% by weight of the entire composition.
